(19) United States
(12) Patent Application Publication
(10) Pub. No.: US 2002/0072414 A1
(43) Pub. Date: Jun. 13, 2002

(54) Pilot internet practice system and methods

(76) Inventors: Donald Stylinski, Glendale, AZ (US); Michael Sharp, Glendale, AZ (US); David J. White, West Chiltington (GB)

Correspondence Address: HONEYWELL INTERNATIONAL INC., 101 COLUMBIA ROAD, P O BOX 2245, MORRISTOWN, NJ, 07962-2245, US

(21) Appl. No.: 09/950,097

(22) Filed: Sep. 10, 2001

Related U.S. Application Data
(60) Provisional application No. 60/231,725, filed on Sep. 8, 2000.

(51) Int. Cl. A63F 13/00

(52) U.S. Cl. 463/42; 434/37

(57) ABSTRACT

According to various exemplary embodiments, a content-providing system for a flight simulator suitably includes a gateway having an interface to a digital network and at least one host computer system executing a server portion of the flight simulator program such that the gateway is operable to receive a request for a connection to the server portion from a user executing a client portion of the flight simulator program over the digital network, and to establish a connection between the client portion and the server portion such that primary processing for the flight simulator takes place at the server portion, and such that interface updates are processed at the client portion.

### FIELD OF THE INVENTION

The invention relates generally to systems and methods for operating simulator programs over a network. More particularly, various embodiments relate to systems and methods for practicing flight or Enhanced Situation Awareness techniques over the Internet or another digital network.

### BACKGROUND

As will be appreciated, pilots and other skilled professionals frequently require many hours of training to develop and maintain skills. Pilots, for example, are often required by government agencies to undergo a certain amount of hours flying, operating simulators, and the like to maintain their pilots' certifications. Additionally, many pilots frequently desire additional training or “practice time” beyond that required by employers or government agencies so that they may develop new skills, learn to operate new equipment, new procedures, and the like.

Different forms of training that are currently available to pilots include customized aircraft simulator systems, software flight simulation programs, or the like. Aircraft simulators generally offer faithful reproduction of aircraft conditions and controls, but are disadvantageous in that they typically require very specialized hardware to operate properly. This hardware is typically very expensive, and is suitable for only a single training session at a time. Hence, organizations such as airlines, the Air Force, and the like may be forced to invest in many copies of each simulator if they are to simultaneously train multiple pilots. This investment may require very large expenditures of cash, as well as support personnel, floorspace, etc. and require the trainee to travel to one or more dedicated training centers. Moreover, updating such specialized hardware for new hardware and software releases may be expensive and cumbersome.

More common simulators (e.g. Microsoft Flight Simulator, available from the Microsoft Corporation of Redmond, Washington) that are capable of executing on a standard personal computer (PC) are relatively inexpensive and readily available, but these products generally exhibit marked disadvantages in that they do not typically provide accurate representations of true aircraft components and conditions. Such programs may not provide full access to flight management system (FMS) programming functionality, for example, or to other components that might be present on a real aircraft. Moreover, “off-the-shelf” simulations may not be available for all types of aircraft, or for all software releases of FMS software, navigation database software, and the like.

Further, simulations such as those available from “off-the-shelf” venders are not typically based upon actual software used in actual aircraft components. Conversion of software from aircraft components to standard personal computers is difficult for many reasons, including difficulties in converting between “big endian” aircraft components and “little endian” PCs. Because the commercial programs are merely designed to emulate the actual aircraft components and are not based upon actual code used in the component, they are not typically reliable for training and practice by actual pilots.

It is therefore desired to create a system and technique whereby pilots may be allowed to practice flight planning, flying and/or enhanced situation awareness (ESA) skills on software that very closely emulates actual software used in cockpit systems. Such a system should be readily available to multiple pilots in a convenient manner and at the location of their choosing.

### BRIEF SUMMARY

According to various exemplary embodiments, a content-providing system for a flight simulator suitably includes a gateway having an interface to a digital network and at least one host computer system executing a server portion of the flight simulator program such that the gateway is operable to receive a request for a connection to the server portion from a user executing a client portion of the flight simulator program over the digital network, and to establish a connection between the client portion and the server portion such that primary processing for the flight simulator takes place at the server portion, and such that interface updates are processed at the client portion.

### BRIEF DESCRIPTION OF THE DRAWING FIGURES

The features and advantages of the present invention are hereinafter described in the following detailed description of illustrative embodiments to be read in conjunction with the accompanying drawing figures, wherein like reference numerals are used to identify the same or similar parts in the similar views, and:

FIG. 1 is a block diagram of an exemplary simulation system;

FIG. 2 is a block diagram of an exemplary software architecture for an exemplary simulation system;

FIG. 3 is a flowchart of an exemplary process for executing a simulation;

FIG. 4 is a flowchart of a second exemplary process for executing a simulation session; and

FIGS. 5A and 5B are exemplary user interfaces for a flight simulator application.

### DETAILED DESCRIPTION OF EXEMPLARY EMBODIMENTS

Various aspects of the present invention may be described herein in terms of functional block components and various processing steps. It should be appreciated that such functional blocks may be realized by any number of hardware and/or software components configured to perform the specified functions. For example, the software elements described herein be implemented with any programming or scripting language such as C, C++, PASCAL, Ada, Java, assembler, PERL, PHP, any database programming language or the like, and the various algorithms may be implemented with any combination of data structures, objects, processes, routines or other programming elements. Similarly, various embodiments could include any type of personal computer, network computer, workstation, minicomputer, mainframe, or other computer running any version of Windows, MacOS, BeOS, Linux, UNIX, Solaris or any other operating system. Further, the various embodiments might employ any number of conventional techniques for data transmission, signaling, data processing, network control, and the like. Radio frequency (RF) or other wireless techniques could be used in place of any network technique described herein, for example. Moreover, although the invention is frequently described herein as being implemented with TCP/IP communications protocols, it will be readily understood that the invention could also be implemented using IPX, Appletalk, IP3, IP-6, NetBIOS, OSI or any number of existing or future protocols. Further, the term “Internet” may refer to the Internet, any replacement, competitor or successor to the Internet, or any public or private internetwork, intranet or extranet that is based upon open or proprietary protocols. Specific information related to the protocols, standards, and application software utilized by in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference. Additionally, the term “web page” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

The particular implementations shown and described herein are illustrative of various exemplary embodiments of the invention and are not intended to limit the scope of the invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections might be present in a practical simulation system. To simplify the description of the exemplary embodiments, the invention is frequently described as pertaining to a system of providing access to aircraft simulators. It will be appreciated, however, that many applications of the present invention could be formulated. For example, the present invention could be used to provide access to any type of simulation, video game, program or other executable program. Moreover, the system provided herein may be used to provide remote access over a computer network to any application residing on a card or other hardware component associated with a server computer.

According to various embodiments of the invention, host computers 134 having one or more simulator cards 136 are coupled to a digital network 106 (such as the internet) via a router or gateway 132. Simulator cards 136 may be any cards or boards capable of residing in host computer 134 and having a processor and/or memory executing one or more simulator programs on the board. An exemplary host computer 134 that includes one or more simulator cards is described in U.S. Pat. No. 6,085,273 issued to Ball et al. on Jul. 4, 2000, incorporated herein by reference. Of course, the host computers 134 described therein may be modified, such as to allow networked access to the various simulator boards 136 as described below. Simulation programs may alternatively or additionally reside in memory or mass storage affiliated with host computer 134, as appropriate.

Users suitably connect to the Internet or other appropriate network 106 via a conventional browser to obtain access to a simulator card on one of the host servers 134. In various embodiments of the invention, user systems 102 suitably contact gateway 132 via network 106 and authenticate with gateway 132 to ensure proper access. Authentication may include checking one or more credentials provided by a user with a record maintained in a database 116. After the user's access is checked, gateway 132 suitably connects the user to a host computer 134 so that the user may execute a simulation session or other application on computer 134. In an exemplary embodiment, users are connected to a processor on a simulation card 136 on host computer 134 so that the user may execute a simulation program over network 106. According to various embodiments, interface information (such as screen images and the like) is stored in a client program residing locally on user systems 102. In such embodiments, interface commands from the user (e.g. keyboard entries and mouse/joystick actions) may be relayed to host 134 over network 106 for processing. Interface updates such as screen refreshes, redraws and the like may be locally processed in response to instructions from host 134 so that “lag” or “delay” produced by network 106 is reduced.

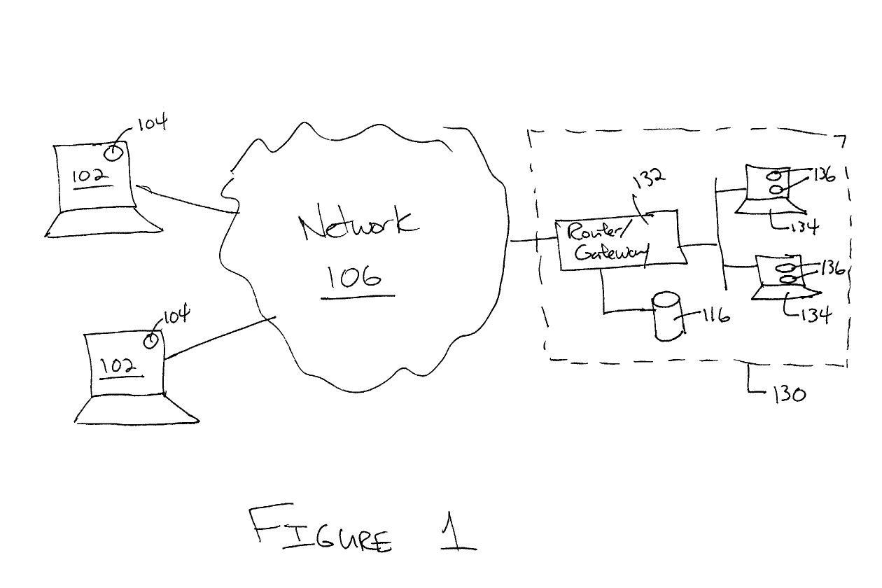

FIG. 1 is a block diagram of an exemplary network simulation system 100. With reference to FIG. 1, one or more client systems 102 communicate with a content-providing system 130 via a network 106 to send and/or receive data. System 130 suitably maintains web pages and other digital content in any conventional manner. In various embodiments, system 130 includes a conventional HTTP server on the World Wide Web (WWW) that provides content (e.g. web pages, ASP content, and the like) to various client systems 102 via the HTTP protocol (or the like) as requested by users of client systems 102. Users suitably view content provided by system 130 via a conventional browser and/or client program, or the like, as described below. Of course multiple systems 130 may be coupled to network 106, and users of client systems 102 may access web pages and other content from multiple systems 130.

Network 106 is any conventional digital network such as the Internet, a private network, the public switched telephone network (PSTN), or any other network based upon any set of communications protocols. In an alternate embodiment, network 106 includes an asymmetrical network architecture (e.g. asymmetrical digital subscriber lines (ADSL)) that typically provides more incoming bandwidth than outgoing bandwidth from a client perspective. In such embodiments, the client/server communications may be optimized to make use of available bandwidth. Such embodiments may mitigate protocol delays resulting from network segments that may not be full-duplex in nature (e.g. modem connections).

According to various exemplary embodiments, content-providing system 130 suitably includes a network interface 108, a gateway/router server 132 having access to a database 116, and one or more host computers 134. As described more fully below, router/gateway 132 is suitably configured to receive requests from user systems 102 via network 108 and to establish corresponding connections between user systems 102 and host computers 134 as appropriate. Database 116 suitably maintains billing and other information that may be used to administer connections and related services.

User systems 102 may include any convenient combination of hardware and software components configured to allow a user to communicate with over network 106. For example, user system 102 might include a standard personal computer (PC) including a CPU, monitor, storage, keyboard, mouse, and communication hardware appropriate for the given data link 104 (e.g., V.90 or other modem, network card, cable modem, DSL modem, etc.). User system 102 might also include one or more peripheral devices such as a scanner, a digital camera, a motion video camera, a TV Tuner card, or the like. In alternate embodiments, user system 102 is a personal data assistant (PDA) capable of manipulating images and communicating with server 110. In yet another embodiment, user system 102 is a kiosk located at a mall, theme park, post office, street, airport, or any other location.

User systems 102 and simulation system 130 are suitably coupled to network 106 via data links 104 and 108, respectively. A variety of conventional communications media and protocols may be used for data links 104 and 108. Such links might include, for example, a connection to an Internet Service Provider (ISP) as is typically used in connection with standard modem communication, cable modem, Dish networks, ISDN, Digital Subscriber Line (DSL), or various wireless communication methods. User system 102 might also reside within a local area network (LAN), intranet, extranet, corporate network or the like which interfaces to network 106 via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

Simulation system 130 (also referred to herein as “simulation server” or “server system”) suitably includes a router/gateway interface 132 to network 106, a database 116, and one or more application servers 134, each of which may contain one or more application cards 136 capable of providing a simulation session to a user. Gateway 132 suitably administers connections from users based upon data maintained in database 116 so that a “virtual session” or “virtual connection” is established between authenticated users and a simulation card 136.

Router/gateway 132 (also referred to herein as simply “gateway 132”) includes any number of hardware, software, and networking components to provide a suitable website or other network-based graphical user interface that is accessible by users on network 106. Gateway 132 further provides the security authentication and access control as described below. In one embodiment, gateway 132 is implemented on a personal computer running the Windows NT operating system in conjunction with an Oracle database 116. In an alternate embodiment, gateway 132 is implemented using Sun Ultra SPARC Enterprise servers with a Solaris or Linux operating system, Apache web server software, and an Oracle, Sybase, MySQL, IBM, Microsoft or other database system. Of course particular hardware and software components used in gateway 132 will vary widely from embodiment to embodiment. Furthermore, gateway 132 may represent a “cluster” or group of separate computer systems providing the functionalities described herein. In such embodiments, for example, gateway 132 may be implemented with a group of routers (such as those available from the Cisco corporation of Mountain View, Calif.) and computer systems, database servers, and the like.

In various embodiments, gateway 132 includes a suitable interface to network 106 such as a network interface card (NIC) and/or appropriate data networking software such as an implementation of the TCP/IP stack, or the like. Of course, gateway 132 is not necessarily directly connected to network 106, but may be coupled to network 106 though any system of cabling, bridges, routers, gateways, data links, and the like.

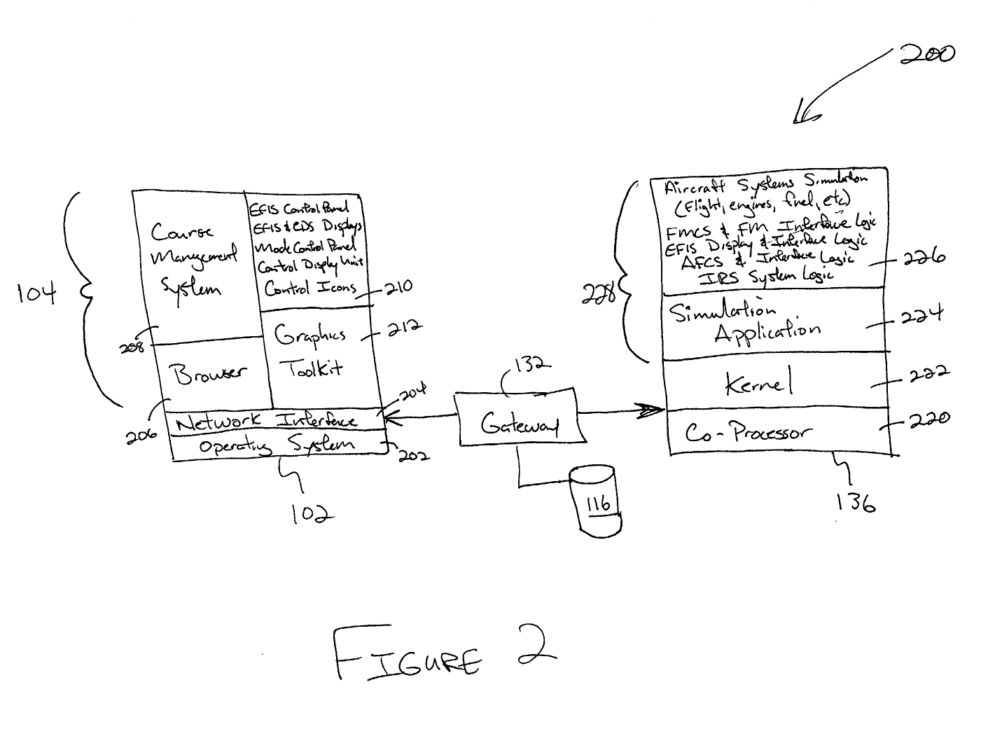

Gateway 132 further includes software instructions stored in a digital storage medium such as a SRAM, DRAM, RDRAM, flash or other memory or on a mass-storage device such as a hard disk, CD-ROM, floppy disk or the like. Software executed at gateway 132 may be written in any programming language, and is described in additional detail below in conjunction with FIG. 2.

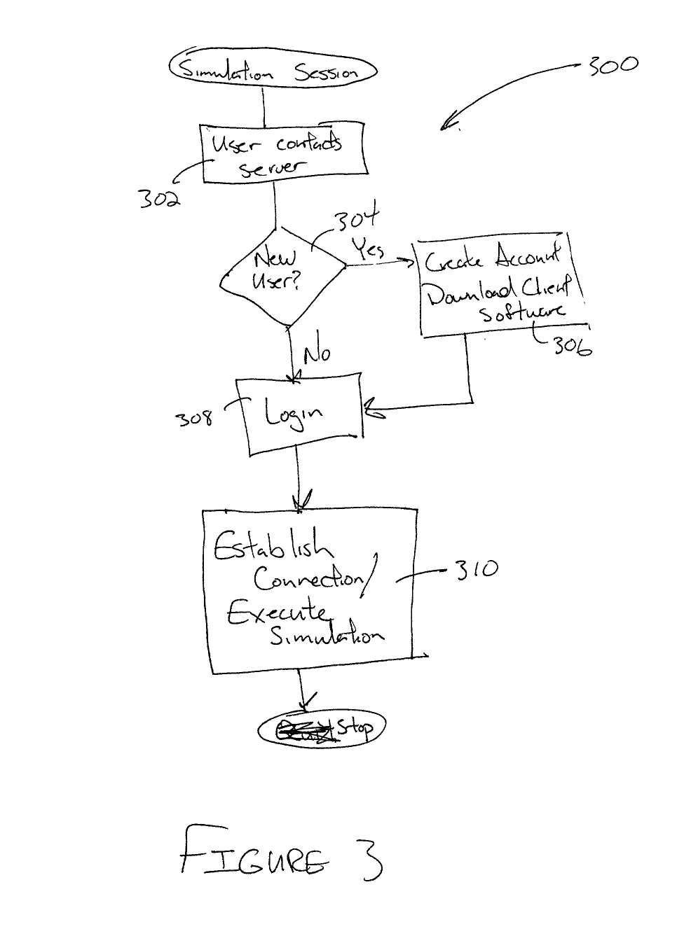

Database 116 is a graphical, hierarchical, relational, object-oriented or other database, and may be maintained on a local drive of server 110 or on a separate computer coupled to server 110 via a local area or other network (not shown). In an exemplary embodiment, database 116 is organized as described below in conjunction with FIG. 3, although of course many other database arrangements may be used.

Each host computer 134 suitably includes a processor and memory, and may be implemented in a conventional workstation or personal computer. In various embodiments, host computer 134 include one or more simulator cards 136 that execute programs that are to be accessed by users across network 106. Exemplary simulator cards 136, for example, include the DeskTop Training System (DTTS) and/or Re-targeted Avionics Co-processor Environment (RACE) cards available from Thales Training and Simulation Ltd. of Crawley, United Kingdom, which simulate aircraft such as the Airbus A320, Boeing 767 and others. DTTS and RACE cards are based upon software that is licensed from the manufacturer of the components used in actual aircraft (e.g. Honeywell International Inc. of Phoenix, Ariz.), so the software executed by the simulation card may be expected to very closely parallel that of an actual aircraft component. Stated another way, the accuracy and reliability of the simulation is improved significantly over “off the shelf” simulation programs because the simulation program executed by the user is based upon the same code that is used in the aircraft. Hence, the value of the simulation and the training is greatly improved.

In various embodiments, the simulator programs are modified or configured such that graphics are not displayed to a monitor or other input/output (I/O) device associated with host computer 134, but rather to a client computer 102 as described more fully above and below. For example, conventional DTTS/RACE cards 134 may be modified such that display functionality is split between a server portion 228 (FIG. 2) resident on the card in host computer 134) and a client portion 104 (which may be provided to user system 102). In such embodiments, simulation processing takes place on the processor affiliated with a card in host computer 134, but graphics are displayed to user system 102 via network 106. This may be accomplished by providing a relatively “thin” client program 104 to user system 102 that is configured to store graphics files (such as graphics affiliated with the various cockpit electronics/components of a particular aircraft) and to display particular graphics files in response to user inputs and updates from the session executing on host computer 134.

FIG. 2 is a block diagram of an exemplary software architecture 200 for a simulation environment 100. With reference to FIG. 2, user systems 102 will typically include an operating system 202 (e.g., Windows, Linux, Solaris, MacOS, etc.) and interface 204 to network 106, as well as various conventional support software modules and drivers typically associated with computers. User system 102 may also include a browser or other application software 206 configured to allow system 102 to communicate over network 106. In an exemplary embodiment, user system 102 includes a conventional Internet browser application 206 that operates in accordance with HTML and HTTP protocols such as Netscape Navigator (available from the Netscape Corporation of Mountain View, Calif. (a division of America Online Inc.) or Microsoft Internet Explorer (available from the Microsoft Corporation of Redmond, Washington). User systems 102 also typically obtain and execute one or more client programs 104 that may be provided by system 130, as appropriate. The “thin” client program 104 may be initiated by a command from gateway 132 to a “plugin” associated with the browser program at user system 102, for example, as described more fully below. Alternatively, the “thin” client may include a plugin, Java applet, ActiveX control, or the like which may be executed within the user's browser 206 by the user, by gateway 132, or otherwise as appropriate.

Client software 104 suitably includes a course management system 208, a graphics toolkit 212 and a library 210 of images, graphics and the like. Course management system 208 suitably manages the execution of simulation client 204 and provides data input/output, tracking of local parameters, and other functions associated with executing the simulation program. Library 210 suitably contains image data in bitmap, GIF, TIFF, JPEG, or any other suitable format suitable for display on the users' computer using an optional graphics toolkit 212. Of course the modules shown in FIG. 2 are exemplary only, and other schemes for maintaining and displaying graphics on system 102 could be formulated. In an exemplary embodiment, graphics maintained within client 104 are tailored to the type of aircraft being simulated. Accordingly, graphics for particular components, cockpits and other interfaces may vary widely from embodiment to embodiment. In an exemplary embodiment, library 210 maintains graphical images for an aircraft electronic flight instrument system (EFIS) including control panels and EFIS displays, an aircraft control display system (CDS), a mode control panel, and/or a control display unit (CDU), in addition to control icons and other conventional images associated with flight simulation programs.

Software executing within the server portion 228 of the simulation program may be written to execute on a kernel other operating system 222 executing on a processor 220 on card 136. In an exemplary embodiment, the simulation programs 228 are written in the C or C++ programming languages to execute within the VERTEX kernel on a card based upon a PowerPC microprocessor available from the Motorola corporation of Austin, Tex. Server software 228 suitably includes a simulation control process/application 224 that controls the simulation session as appropriate. In an exemplary embodiment, control application 224 suitably uses a library of logic routines for executing such functions as processing simulations of particular aircraft functions (e.g. FMS, engines, fuel consumption, etc.) as well as processing interface updates for aircraft-related functions such as flight management/flight management computer systems (FMCS), EFIS displays, automatic flight control systems (AFCS), inertial reference systems (IRS), and the like. As described above, processing of the simulation is generally handled by server software 228, with interface update instructions being sent to client application 104 to reduce network traffic and to improve response times.

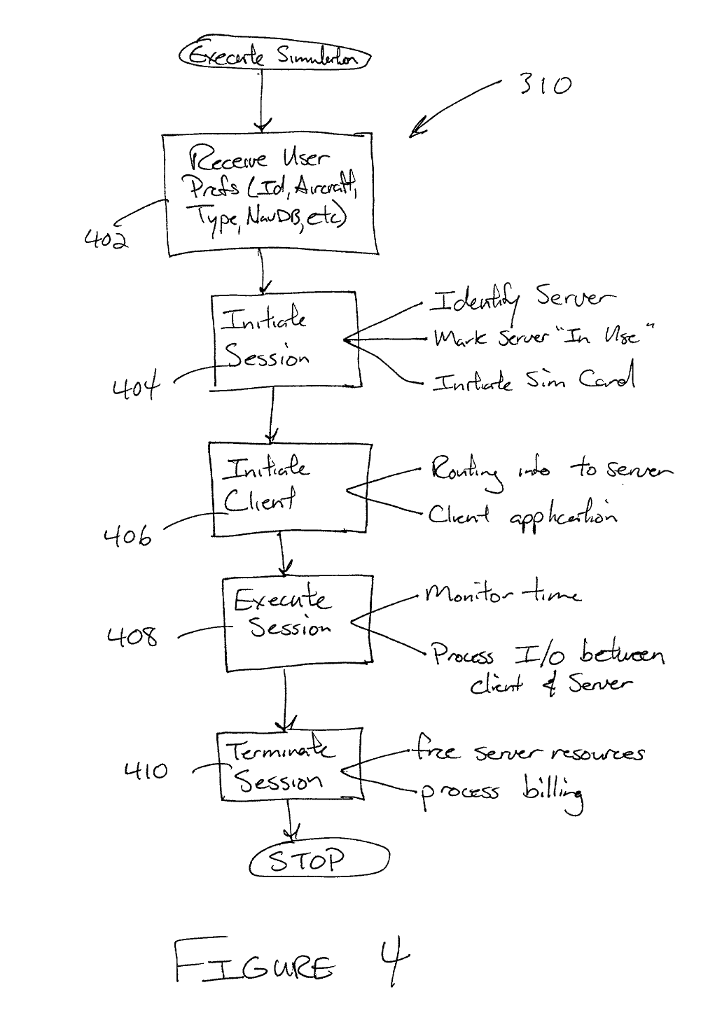

Software executed by gateway 132 is described in conjunction with FIGS. 3 and 4. In an exemplary embodiment, gateway 132 suitably includes conventional web server software including active server pages (ASP), HTML documents and CGI programs. These programs suitably receive connections, identify an available processor/card on a host computer 134, ensure that users are authorized to use system 130, and ensure that data is passed between host computer 134 and user system 102 as appropriate and as described more fully below.

Ado FIGS. 3 and 4 are flowcharts of exemplary processes for handling simulation connections/sessions. With reference now to FIG. 3, an exemplary process 300 for handling a connection suitably includes starting a session in response to a user request (step 302), creating a new account if appropriate (steps 304 and 306), logging the user into the server system (step 308), establishing a client-server connection and executing the simulation (step 310).

In an exemplary embodiment, a user of a client system 102 (FIG. 1) suitably requests a connection (step 302) by entering a uniform resource locator (URL) associated with gateway 132 (FIG. 1) into a browser or other network application executing at client computer system 102. Browser 206 suitably creates an HTTP session with gateway 132 across network 106 using conventional techniques.

After establishing an HTTP connection, gateway 132 suitably provides an HTML or other document requesting a login credential such as a userid/password, smartcard access code, physical characteristic or the like. If the user is a new user (step 304), gateway 132 suitably creates a new account entry in database 116 for the user and provides appropriate client software to client computer 102 (step 306). Information retained in database 116 for each user may include contact information (e.g. name, address, phone number, email address and the like), demographic information, preferences (e.g. preferences for aircraft type, engine configuration, user settings and the like), security credentials (e.g. userid/password information), a customer affiliation (e.g. airline, government account, employer or the like), and/or payment information (e.g. credit/debit card information, smartcard information, or other billing information) and other information as appropriate for the particular embodiment. In various embodiments, database 116 may also retain “reservations” for a particular simulator processor for a user at a particular time to ensure that that a particular configuration is available when needed by the user.

Software provided to client system 102 may include a browser plugin/applet/control as well as other software components as discussed above. In such embodiments, the plugin/applet/control typically interacts with the browser to activate the other components as appropriate.

As mentioned briefly above, users log on to system 130 (step 308) by providing a digital credential such as a userid/password combination, digital signature or the like before receiving continued access to simulation system 130. Such credentials may be verified by checking the credential against an earlier entry in database 116, for example, by querying an external host (such as a credit card authorization system) for authorization, or through any other technique. When the credential is verified, processing continues by establishing a virtual connection between the client and server portions of the simulation program and executing the simulation (step 310).

With reference now to FIG. 4, an exemplary process 310 for executing a simulation suitably proceeds by receiving user preferences (step 402), initiating the server and client portions of the application software (steps 404 and 406, respectively), executing the session (step 408) and administering “clean up” functionality after the user terminates the session (step 410).

After a user has successfully logged into system 130, gateway 132 suitably retrieves a set of user preferences for the simulation session to be created (step 402). Preferences may be retrieved from database 116, from user system 102, or may be entered manually by the user into a web-based form, active server pages, or the like. Preference data typically describe the user's preferred choices for aircraft type, navigation database version, engine configuration and the like. Simulation parameters (e.g. starting point, weather conditions and the like) may also be specified with preference data.

When the type of simulation desired by the user has been specified, system 130 suitably initiates a session by identifying an available CPU for running the server portion of the simulation, marking that CPU as “in use”, and initiating the card running the simulation. In various embodiments, an available card 136 (FIG. 1) is identified by placing a query to database 116 for a card capable of executing the simulation session requested by the user. If a card 136 is available, gateway 132 suitably retrieves the IP address and port number for the particular card from database 116 and notifies database 116 that the card is no longer available for use. Gateway 132 also creates a session ID and a session history log with the time, date, login information, session ID, and server/CPU identification for later tracking and billing purposes. Gateway 132 then activates the server application 224 running on the identified card 136 and passes any parameters (e.g. navigation database version, engine configuration and the like) to the card that may be appropriate for the particular session.

When the appropriate server application 224 is running, gateway 132 suitably provides a web page to client system 102 that includes an embedded object to start the plugin/applet/control running at client 102 and to thereby activate the client portion 104 of the simulation software (step 406). Information passed to the client includes the session ID generated above, and may also include the IP address, CPU identification and/or port number of the server card assigned to the particular session. Client application 104 then executes as a stand-alone application, as a Java applet within browser 206 (FIG. 2), or otherwise as appropriate.

As the simulation session executes (step 408), gateway 132 suitably routes network communications between the client and server portions of the simulation software as appropriate through system 130. As stated above, network communications need not include all details of the simulation, since the client and server portions of the simulation program handle separate tasks. Accordingly, client application 104 transmits user inputs from the keyboard, joystick, mouse, etc. to server application 228 for processing, and instructions for interface adjustments are returned from server 228 to client 104. Since client application 104 contains the graphics files for the interface prior to the initiation of the session, rapid adjustments may be made without the need for transmitting large blocks of data over network 106. Various embodiments of gateway 132 additionally store a “snapshot” of the user's current session (e.g. including session id, preferences, and current simulation parameters such as altitude, airspeed, programmed flight plan, etc.) at periodic intervals so that the session may be re-constructed and continued if service is interrupted or suddenly disconnected. Gateway 132 also monitors the time that the simulation executes, as appropriate.

After the simulation session is complete, the session is terminated (step 410).

When client application 104 is terminated, control returns to the user's web browser 206, and server application 134 is notified. Gateway 132 suitably updates the history log to reflect the time used and to reset the availability flag for the server in database 132. Billing for the session may also be processed as appropriate. Users may be billed for the use of system 130 according to any scheme, such as a “pay per use” scheme, a flat fee scheme, or any combination of the two. In an exemplary embodiment, gateway 132 suitably tracks minutes or hours of usage for each user so that a fee based upon actual time of use may be assessed. Alternatively, users or groups of uses (e.g. pilots employed by a common airline) may receive a set amount or an unlimited amount of usage for a daily, weekly, monthly or annual fee. Payment may be collected in advance (e.g. for a pre-set period of access time) or in arrears (e.g. based upon actual usage). In an exemplary embodiment, fees for access to system 130 are charged to a credit card, debit card or other payment credential provided by a user. Users may alternatively or additionally be associated with corporate accounts for billing to airlines, government agencies, or the like.

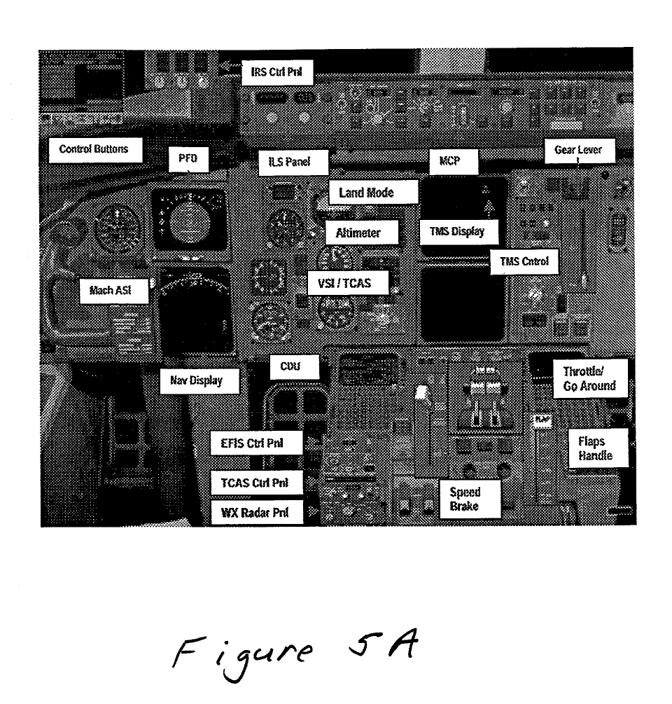

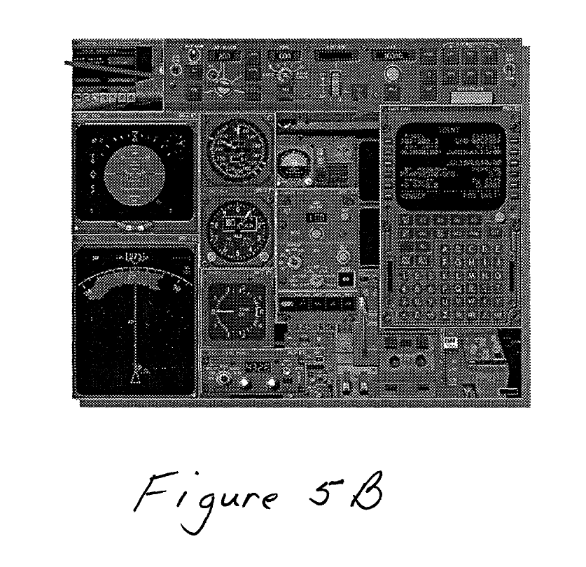

FIGS. 5A and 5B show exemplary user interfaces provided by client program 104. With reference now to FIGS. 5A and 5B, an embodiment that includes an aircraft simulation suitably displays various aircraft components within a browser window on the user's display. The client is appropriately responsive to user commands from the keyboard, mouse, joystick etc. such that components of the simulated aircraft (such as the flight management system, autopilot, navigation display, flight controls, and the like) are activated and/or manipulated by the user to effect the simulation. The client program suitably sends input from the user to the host computer 134 for processing, and displays output from host computer 134 as appropriate. Because host computer 134 processes the non-graphical elements of the simulation (e.g. navigation, FMS programming, and the like), processing demands upon client computer 102 are reduced significantly compared to conventional simulation programs. Accordingly, a highly-functional and highly “true-to-life” simulation program is provided to remote users in a standardized, convenient, easy-to-use and globally-accessible manner.

In a further embodiment, the client/server architecture described herein may be used with conventional distributed mission training (DMT) techniques. In such embodiments, the systems described herein may replace one or more aircraft simulators during training exercises conducted in a distributed environment. Such exercises may take place in a distributed interactive simulation (DIS) environment, over a high level architecture (HLA) network, or the like. In such embodiments, sessions executing on multiple hosts 134 or cards 136 suitably inter-communicate simulation parameters such as aircraft position, velocity, heading and the like, or provide such information to a simulation server application (not shown) that administers the simulation session as appropriate.

It will also be appreciated that the systems and techniques described herein will be useful in training pilots in enhanced situation awareness (ESA). Such techniques typically combine FMS functionality with that of one or more other components (e.g. traffic collision avoidance systems (TCAS), radar (WXR), ground proximity warning (EGPW), future air navigation system (FANS), ARINC communications and reporting system (ACARS), automatic dependence surveillance (ADS/ADS-B), controller/pilot data link comunications (CPDLC), voice or data communications, and/or the like) for improved safety of the aircraft.

Of course other embodiments and applications of the system and technique described herein may be formulated without departing from the scope of the present invention. The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above. The steps recited in any method claims may be practiced in the order recited, or in any other order. No elements or components are necessary to the practice of the invention unless specifically described herein as “essential” or “required”.

What is claimed is:

1. A content-providing system for a flight simulator, said system comprising:
a gateway having an interface to a digital network; and
at least one host computer system executing a server portion of said flight simulator program;
wherein said gateway is operable to receive a request for a connection to said server portion from a user executing a client portion of said flight simulator program over said digital network, and to establish a connection between said client portion and said server portion such that primary processing for said flight simulator takes place at said server portion, and such that interface updates are processed at said client portion.

2. The content-providing system of claim 1 further comprising a database in communication with said gateway.

3. The content-providing system of claim 2 wherein said gateway is further operable to establish said connection based upon authentication of said user based upon information contained in said database.

4. The content-providing system of claim 2 wherein said database comprises billing information.

5. The content-providing system of claim 1 wherein said server portion comprises executable code derived from an actual aircraft component.

6. The content-providing system of claim 5 wherein said actual aircraft component is a flight management system (FMS).

7. A method of providing access via a digital network to a program at a content-providing system, the method comprising:
receiving a request for a connection from a client system via said digital network at a gateway associated with said content-providing system;
establishing a connection between said client system and said program across said digital network via said gateway;
executing said program at said content-providing system; and
providing instructions from said program to said user from said content-providing system, said instructions corresponding to an update to a user interface executing at said client system.

8. The method of claim 7 wherein said step of establishing said connection comprises:
receiving an authentication credential at said host computer system; and
correlating said credential with an entry in a database at said content-providing system to verify that said user is permitted to use said program.

9. The method of claim 7 further comprising the step of monitoring a time of usage at said content-providing system.

10. The method of claim 9 further comprising the step of maintaining billing information at said content-providing system, wherein said billing information is correlated to said time of usage.

11. The method of claim 7 wherein said program is an aircraft simulation program.

12. The method of claim 11 wherein said aircraft simulation program is based upon software code used in an aircraft component.

13. The method of claim 12 wherein said aircraft component comprises a flight management system.

14. The method of claim 13 wherein said program is stored on a card executing on a host computer associated with said content-providing system.

15. A system for providing access to a computer application over a network, said system comprising:
an interface to said network;
a plurality of cards, each of said plurality of cards comprising a card processor configured to execute one of said plurality of computer applications; and
a host processor in communication with said interface and with each of said plurality of cards, wherein said host processor is operatively configured to provide access to one of said plurality of card processors via said network.

16. The system of claim 15 wherein each of said plurality of computer applications comprises an aircraft simulation program.

17. The system of claim 16 wherein said aircraft simulation program is based upon software code used in an aircraft component.

18. The system of claim 17 wherein said aircraft component is a flight management system.

19. The system of claim 15 wherein said network is a distributed interactive simulation (DIS) network.

20. The system of claim 15 wherein said network is a high level architecture (HLA) network.

21. The system of claim 19 wherein said system is connected through said DIS network to a distributed mission training (DMT) Scenario.

22. The system of claim 20 wherein said system is connected through said HLA network to a distributed mission training (DMT) Scenario.
